(19) United States
(12) Patent Application Publication
(10) Pub. No.: US 2014/0299557 A1
(43) Pub. Date: Oct. 9, 2014

(54) ARTICLE AND METHOD FOR VENTING A PROCESSING VESSEL

(71) Applicant: DOW GLOBAL TECHNOLOGIES LLC, Midland, MI (US)

(72) Inventors: Xindi Yu, Midland, MI (US); James F. Koch, Gagetown, MI (US); Jim M. Grider, Freeland, MI (US)

(21) Appl. No.: 14/356,699

(22) PCT Filed: Aug. 9, 2012
(86) PCT No.: PCT/US12/50112

§ 371 Date: May 7, 2014

Related U.S. Application Data
(60) Provisional application No. 61/588,313, filed on Jan. 19, 2012.

(51) Int. Cl. B01D 29/66; B01D 29/70; H01M 4/04; B01D 29/62

(52) U.S. Cl. CPC B01D 29/66; B01D 29/62; B01D 29/70; H01M 4/04
USPC 210/791; 210/407; 210/391; 210/409; 210/767

(57) ABSTRACT

A device for venting a processing vessel (2) comprising: a separation unit (20) including a fluid permeable separator (26) for separating a solid from a fluid present in a fluidic solid dispersion, the separation unit (20) having an interface component (22) for attachment to a wall (8) of a processing vessel (2) in a manner so that the interface component generally integrates with the wall forming a substantially contiguous wall surface and a cleaning mechanism (50) that is in fluid communication with the separation unit (20) and that is adapted to extract the fluid that is separated from the fluidic solid dispersion from the processing vessel, and to periodically and/or continuously agitating the solids on the surface of the separation unit so that the fluid can pass through the separator.

### CLAIM OF PRIORITY

This application claims the benefit of U.S. Provisional Patent Application Ser. No. 61/588,313, filed Jan. 19, 2012, the contents of which are incorporated by reference herein.

### FIELD

The present teachings generally relate a venting device for use with a processing vessel, and more specifically a separation unit and cleaning device so that solids are separated from a fluidic solid dispersion and a constant stoichiometric ratio of the components in the processing vessel is maintained.

### BACKGROUND

The present teachings are predicated upon providing an improved device for venting a processing vessel. Generally, most venting devices include an apparatus to remove solids from a fluid stream so that the fluid can exit the processing vessel and/or vent without maintaining any solids in the fluid stream. One problem occurs when moisture is present in the fluid stream. The moisture may cause the solids to accumulate on and/or in the venting device so that venting is impaired and/or completely prevented. One solution that has been attempted is to make the venting apparatus larger so that the surface area to remove the solids is increased, thus, allowing for venting even if solids accumulate on or in the venting device. This solution may allow for a continued flow of the fluid through the venting apparatus while maintaining the solids in the venting apparatus; however, the accumulation of a large amount of solids in the venting apparatus may affect the stoichiometric ratio of components in the processing vessel and affect the final product. Further the frequency of cleaning the system is long in order to achieve an efficient cleaning and the length between cleanings may negatively affect the stoichiometric ratio of the components in the processing vessels. Other solutions attempt to frequently clean the venting apparatus in order to force the solids back into the processing vessel; however, the amount of solids in the venting vessel may be low enough so that cleaning is inefficient, and the stoichiometric ratios of the solids in the processing vessel remain affected due to the solids retained in the venting vessel. Yet another solution has been to use a cyclone to remove solids from the fluidic solid dispersion. The cyclone may remove a majority of the particles; however, some of the smaller and/or lightweight particles may be vented from the cyclone affecting the stoichiometric ratio and total mass of particulated particles in the system.

Examples of such are venting devices are disclosed in U.S. Pat. Nos. 4,102,089 and 4,263,100; and U.S. Patent Application Nos. 2004/0093682 and 2005/274094 all of which are expressly incorporated herein by reference for all purposes. What is needed is a venting apparatus that allows for fluids and other unwanted byproducts to be removed from the processing vessel without changing the stoichiometric ratios of the solids in the processing vessels. What is needed is a separation unit that retains substantially all of the solids from a fluidic solid dispersion in a processing vessel. What is further needed is a separation unit that includes a low trapping volume so that a minimum amount of material is trapped inside the separation unit. What is further needed is a separation unit that allows for a high frequency of cleaning with a high efficiency so that solids are not removed from the process in the processing vessel for an extended period of time.

### SUMMARY

One possible embodiment of the present teachings include: a device for venting a processing vessel comprising: a separation unit including a fluid permeable separator for separating a solid from a fluid present in a fluidic solid dispersion, the separation unit having an interface component for attachment to a wall of a processing vessel in a manner so that the interface component generally integrates with the wall forming a substantially contiguous wall surface and a cleaning mechanism that is in fluid communication with the separation unit that is adapted to extract the fluid that its separated from the fluidic solid dispersion from the processing vessel, and to periodically and/or continuously agitating the solids on the surface of the separation unit so that the fluid can pass through the separator.

One possible embodiment of the present teachings include: a method for venting a solid state processing vessel comprising: mixing a plurality of solid state particulated reaction ingredients under conditions in which reactions may occur, undesired by-products may form, or both and venting the solid state processing vessel through a separation unit that is contiguous with a wall of the processing vessel so that a constant stoichiometric ratio of the plurality of solid state particulated reaction ingredients is maintained, and undesired by-products are removed.

The teachings herein surprisingly solve one or more of these problems by providing a venting apparatus that allows for venting of the unwanted byproducts such as moisture of volatiles without removing the solids from the processing vessel. The teachings herein provide a venting apparatus that allows for fluids and other unwanted byproducts to be removed from the processing vessel without changing the stoichiometric ratios of the solids in the processing vessels. The teachings herein provide a separation unit that retains substantially all of the solids from a fluidic solid dispersion in a processing vessel. The teachings herein provide a separation unit that allows for a high frequency of cleaning with a high efficiency so that solids are not removed from the process in the processing vessel for an extended period of time.

### BRIEF DESCRIPTION OF THE DRAWINGS

FIG. 1 illustrates an exploded view of one embodiment of the venting device taught herein;

FIG. 2 illustrates an example of a processing vessel including the venting device of the teachings herein;

FIG. 3 illustrates an example of the venting device being agitated;

FIG. 4 illustrates a cross-sectional view of a venting device and processing vessel;

FIG. 5A illustrates a close-up cross-sectional view of one possible configuration of a venting device; and

FIG. 5B illustrates a close-up view of a porous protective surface.

### DETAILED DESCRIPTION

The explanations and illustrations presented herein are intended to acquaint others skilled in the at with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The present teachings herein include a device for venting a processing vessel. The device may be any device so that a fluid is removed from the processing vessel while the solids are maintained substantially within the processing vessel. The processing vessel may be any type of vessel that holds particulated ingredients (e.g., solids). The processing vessel may be any processing vessel where a substantially constant stoichiometry is maintained. The processing vessel may be any processing vessel where particulated ingredients are introduced in order to b processed. The processing vessel may be any type of vessel that processes components for an article of manufacture. The processing vessel may be used to process particulate materials in an intermediate or final form. The processing vessel may be used to process particulate matter for use in manufacturing acicular mullite, anodes, cathodes, battery electrode materials, powder for ceramics, powder metal and alloys, powder polymers, organic chemicals, inorganic chemicals, or a combination thereof. Preferably, the processing vessel may be any processing vessel used in the manufacture of materials for batteries. More preferably, the processing vessel may be any processing vessel used in the manufacture of materials for lithium on batteries. Most preferably, the processing vessel may be any processing vessel used in the manufacture of precursor materials used in the manufacture of an anode or a cathode of a lithium ion battery. The processing vessel may be static or may move during processing. The processing vessel may be used to pulverize and mix materials, induce chemical reactions within or among materials, vent and dry materials, heat materials, pre-heat materials, or a combination thereof. Preferably, the processing vessel may be used to reduce the average particle size of materials, mix materials, cause mechanical fusion, or a combination thereof. More preferably, the processing vessel may be used to refine particulated materials.

The processing vessel may be a pulverizer, a mixer, a refiner, the like, or a combination thereof. Preferably, the processing vessel may be an agitated media mill (e.g., a ball mill). More preferably, the processing Vessel may be an agitated media mill. Most preferably, the processing vessel may be a high energy mill that includes a media such as steel balls or ceramic balls. The processing vessel may be used for batch manufacturing, continuous manufacturing, or both. The processing vessel may include agitated media. The agitated media may be any device added to the processing vessel that assists in refining the solid state particulated reaction ingredients. For example, the agitated media may be metal balls, ceramic balls, or both. The media may move in the mill in such a manner that the media is moving substantially parallel to the end wall of the processing vessel, the venting apparatus, or both. Preferably, any contact between the media and the end walls, the venting apparatus, or both may be tangential so that the force on the end wall, the venting apparatus, or both will be low. For example, the media may not contact an end wall, a venting apparatus, or both at a right angle. The processing vessel may be used for continuous manufacturing, The processing vessel may be used for calcination. The processing vessel may be used to process one or more components. The processing vessel may be used to process solid materials. The materials processed in the processing vessel may be one or more solid state articulated reaction ingredients. Preferably, the processing vessel may include a plurality of solid state particulated reaction ingredients. More preferably, the solid state particulated reaction ingredients are battery electrode precursor ingredients. Even more preferably, the solid state particulated reaction ingredients are precursor materials for creating a lithium metal phosphate cathode material. The solid state particulated reaction ingredients may contain elements such as organic materials, inorganic material, natural material, synthetic materials, carbon, lithium, manganese, iron, phosphate, zinc, cobalt, aluminum, nickel, or mixtures thereof. The processing vessel may include a fluid inlet on one side and the venting apparatus as taught herein on an opposing side of the processing vessel so that a venting fluid is introduced into the processing vessel. However, the fluid inlet may be at any location so that the processing vessel maintains an inert atmosphere, the stoichiometry of the processing vessel is maintained substantially constant, or both. The venting fluid may be the same or a different fluid as the cleaning mechanism. The fluid inlet may introduce the venting fluid so that the processing vessel is maintained at a slight pressure so that gas, water, unwanted vapors, or a combination thereof are removed from the processing vessel through the venting apparatus. The processing vessel may be free of a fluid inlet. The processing vessel may be discrete from the venting apparatus. Preferably, the venting apparatus may be integrated into the processing vessel.

The venting apparatus and the fluid inlet may be used in conjunction with each other so that an inert atmosphere is maintained within the processing vessel. The venting apparatus may include a separation unit and a cleaning mechanism. The separation unit may be any device that separates solids from a fluidic solid dispersion. The separation may include one or more parts that may assist in separating solids from a fluidic solid dispersion. The separation unit may be located with respect to a wall of the processing vessel such that it separates solids from a fluidic solid dispersion. The separation unit may be adjacent to a wall of the processing vessel. All or a portion of the separation unit may form a part of the wall. All or a portion of the separation unit may be positioned in a wall of the processing vessel so that a wall of the processing vessel and the separation unit are generally contiguous. All or a portion of the separation unit may be contiguous with a wall of the processing vessel so that the stoichiometric ratio of the solid state particulated reaction ingredients are maintained in the processing vessel. The separation unit may include: an interface component for connecting to the processing vessel; a forward protective surface; a separator (e.g., a membrane, filter, the like, or a combination thereof); a rear protective surface: a spacer; a connection adapter; one or more O-rings, seals, washers, or a combination thereof. The separation unit may include a trapping volume. The trapping volume may be the maximum volume of any material that the separation may hold. The trapping volume may be measured on the processing vessel side of the separator. For example, the trapping volume may be the area of the separator that fluid passes through plus the thickness of the forward porous protective surface minus the total area of the protective members.

The interface component may be any device, feature, and/or component that may attach the separation unit to another device. The interface component may be any device that attaches the separation unit to a processing vessel. The interface component may be connected to a wall of a processing unit so that the interface component and the separation unit are generally planar with the wall, generally contiguous with the wall, or both. The interface component may be attached to another component (e.g., the cleaning mechanism, a wall of the processing vessel, or both) by any device useful for fastening (e.g., a fastener). The interface component may be bolted, screwed, glued, molded, adhesively bonded, attached via a mechanical coupling assembly, interference fit, threaded and screwed into or vice versa, welded, or a combination thereof to another component. Preferably, the interface component is placed through a hole u a processing vessel and then bolted to the processing vessel. The interface component may include a portion that is parallel to a wail of the processing vessel. The interface component may include a portion that is perpendicular to the portion that is parallel to a wall of the processing vessel. The interface component may be free of any parts that extend out of the wall. For example, the interface component may be adhesively bonded or molded into a hole in the wall and the interface component may attach to the cleaning mechanism in the hole so that the entire interface component is located in the wall of the processing vessel. The interface component may include a portion that enters a hole in a wall of the processing vessel. The interface component may be any size and shape so that at least a portion of the interface component may tit within a processing vessel wall, protect the separation unit, attach the separation unit to a processing vessel, or a combination thereof. The interface unit, the hole in the wall, the separation unit, or a combination thereof may vary in size depending on the size of the processing vessel. The interface unit, the hole in the wall, or both have an opening of between about 2 cm and about 20 cm, preferably between about 3 cm and about 10 cm, and more preferably between about 4 cm and 6 cm. The interface component, preferably, is large enough so that a sufficient amount of fluid is vented from the processing vessel so that the processing vessel maintains an inert atmosphere. The interface component in combination with the cleaning mechanism may enable the processing vessel to maintain an inert atmosphere for the entire duration of each use. The interface component may be sized so that any agitated media that may be used in the processing vessel may be substantially prevented from contacting a separator. The interface component may be made of any material that may be useful in attaching the separation unit to a processing vessel. The interface component may be made of any material that is abrasion resistant, corrosion resistant, withstand impacts from abrasive particles, metal components, or a combination thereof. The interface component may be made of ceramic, metal, plastic, rubber, composites, or a combination thereof. Preferably, the interface component is made of stainless steel or hardened steel. The interface component may include a protective surface so that the interface component, the separation unit, or both are protected from components of the processing vessel. The interface component may include a forward protective surface.

The forward protective surface may protect the separation unit from the components of the processing vessel. The forward protective surface may protect the separation unit from agitated media. For example, if an agitated media mixer is used the mixer may include agitated media that may he moved throughout the processing vessel and the forward protective surface may protect the separation unit from being damaged by the agitated media. The forward protective surface may be chamfered. The forward protective surface may be cut at an angle such that any contact between the components in the processing vessel and the forward protective surface do not bend, break, remove material, or a combination thereof from the forward protective surface. The angle and/or curve of the forward protective surface may be any angle and/or curve so that any contact between the components of the processing vessel and the forward protective surface are glancing and do not damage, break, bend, remove material, or a combination thereof of the interface component. The chamfer of the forward protective surface may have an angle of between about 15 degrees and about 90 degrees, preferably between about 20 degrees and about 80 degrees, and more preferably between about 35 degrees and about 60 degrees about 45 degrees) with a wall of the processing vessel. The forward protective surface may be radiused or rounded. The forward protective surface may be both chamfered and radiused or curved. The forward protective surface may be radiused or rounded so that any contact between the components of the processing vessel and the forward protective surface do not break, bend, damage, remove material, or a combination thereof from the forward protective surface. Preferably, the forward protective surface is a curved surface that includes a radius. The radius of the forward protective surface may be about 0.1 mm or more, about 0.5 mm or more, or preferably about 1 mm or more. The radius of the forward protective surface may be between about 3 cm and about 0.2 mm and preferably between about 2 cm and about 0.5 mm. The forward protective surface may protect a forward porous protective surface from being contacted by of a portion of the contents of the processing vessel.

The forward porous protective surface may be any surface that allows a fluid to pass through pores in the protective surface while preventing at least some agitated media frail passing the protective porous surface. The forward porous protective surface may prevent all or a portion of the solid contents of the processing vessel from exiting the processing vessel. Preferably, the porous protective surface prevents at least the agitated media of the processing vessel from exiting the processing vessel. The size of the pores in the forward porous protective surface may vary based upon the media in the processing vessel. The pores may be of any shape and size. The pores may be of any shape and size so that the remaining material is sufficiently strong to protect the separator from the contents of the processing vessel. The pores may be circular, square, long, short, diamond, rectangular, irregular, or a combination thereof. Preferably, the pores are vertical slots. The forward porous protective surface may act as a reinforcing member. The forward porous protective surface may be rigid. Preferably, the forward porous protective surface is flexible so that when compressed gas is applied the membrane, the forward protective surface, or both flex so that at least some solid particles are removed and/or loosened from the separator. The forward porous protective surface may be any thickness so that the forward porous protective surface elastically deforms during contact with the agitated media, the compressed fluid, or both. The forward protective surface, the separator, or both may be flexed from contact by the agitated media, compressed fluid, or both so that solid material is removed from the separator. The forward porous protective surface may have any thickness so that the forward porous protective surface protects the separator and the forward porous protective moves so that solid particles are removed from and/or loosened from the separator. The forward porous protective surface may have a thickness of about 0.001 mm or more, about 0.05 mm or more, preferably about 0.1 mm or more, or more preferably about 0.2 mm or more. The forward porous protective surface may have a thickness of about 1 cm or less, about 5 mm or less, about 1 mm or less, or about 0.5 mm or less. The forward porous protective s dace may have a thickness between about 1 mm and about 0.1 mm and preferably between about 0.4 mm and at 0.2 mm (i.e., about 0.25 mm). The thickness of the porous protective surface may vary based upon the material characteristic of the materials used for the porous protective surface. For example, a plastic porous protective surface may be thicker than a steel porous protective surface. The forward porous protective surface may include protection monikers that protect the separator.

The protection members may be any portion that extends across an opening in the separation unit that allows the fluidic solid dispersion to be vented. The protection members may be of any size and shape that protects the separator. The protection members may be any size and shape that allows fluid to pass through the forward protective surface to the separator. Preferably, the protection member is made of a material that is abrasion resistant. The protection members, the forward porous protective surface, or both may be made of metal, ceramic, plastic, rubber, composites, or a combination thereof. The protection members may be bars. The protection members may include the pores. The protection members may be any configuration so that the protection members prevent at least the agitated media from contacting the separator. The forward porous protective surface may reinforce the interface component, the separator, the wall of the processing vessel, or a combination thereof. Preferably, the forward porous protective surface protects the separator from being damaged from the solid contents of the processing vessel hitting the separator. More preferably, the forward porous protective surface protects the separator from being damaged by the agitated media in the processing vessel.

The separator may be any device, feature, member, or a combination thereof that separates solids from a fluidic solid dispersion. The separator may be fluid permeable so that fluids may pass through the separator and solids may be prevented from exiting the processing vessel. Preferably, the separator may filter solid state particulated reaction ingredients from the fluidic solid dispersion. More preferably, the separator may filter solid particles with a largest dimension of about 100 microns or smaller, preferably about 10 microns or smaller, more preferably about 1 micron or smaller, or even about 0.1 micron or smaller. For example, the separator may remove dust like particles from the fluidic solid dispersion. The separator may be made of any material that separates the solids from the fluidic solid dispersion. Preferably, the separator may be made of any material that sufficiently separates the solids from the fluidic solid dispersion so that the stoichiometry of the contents of the processing vessel are not affected by the venting of the processing vessel. The separator may be a membrane. The separator may be made of a woven or non-woven fabric, a plastic, a metal, an organic material, an inorganic material, a polymeric material, a synthetic material, a natural material, a composite material, a porous ceramic such as acicular mullite, a silica, a metal oxide, a foam that performs the recited functions, or a combination thereof. Preferably, the separator is made of a flexible porous membrane material. More preferably, the separator is made of Polytetrafluoroethylene (PTFE), a glass mat, polyester, a polyamide, cellulose fibers, or a combination thereof. The separator may be located anywhere in the separation unit. Preferably, the separator may be located behind and in contact a forward porous protective surface to erasure minimum trapping volume for the solids. The separator may be located in front of a rearward porous protective surface. Most preferably, the separator is sandwiched between a forward porous protective surface and a rearward porous protective surface.

The rearward porous protective surface may be any surface that allows a fluid to pass through pores in the protective surface. The rearward porous protective surface may prevent all or a portion of the solid contents of the processing vessel from exiting the processing vessel. Preferably, the rearward porous protective surface prevents at least the agitated media of the processing vessel from exiting the processing vessel. The size of the pores in the rearward porous protective surface may vary based upon the media in the processing vessel. The pores may be of any shape and size. The pores may be of any shape as size so that the remaining material is sufficiently strong to protect the separator from the contents of the processing vessel, contents in the cleaning mechanism, or both. The pores may be circular, square, long, short, diamond, rectangular, irregular, or a combination thereof. Preferably, the pores are vertical slots. The pores of the rearward porous protective surface may be substantially the same size as the pores of the forward protective surface. Preferably, the pores in the rearward porous protective surface are substantially aligned with the pores in the forward porous protective surface so that the resistance on the fluidic solid dispersion is minimized. The pores of the rearward porous protective surface may be smaller than the pores of the forward porous protective surface. The pores of the rearward porous protective surface may be larger than the pores of the forward porous protective surface. The rearward porous protective surface may act as a reinforcing member. The rearward porous protective surface may reinforce the interface component, the membrane, the wall of the processing vessel, or a combination thereof. Preferably, the rearward porous protective surface protects the membrane from being damaged by the solid contents of the processing vessel, the cleaning mechanism, or both. More preferably, the rearward porous protective surface assists in protecting the separator from being damaged by the agitated media in the processing vessel. The rearward porous protective surface may flex during application of compressed air. Preferably, the rearward porous protective surface is free of flexing during the application of compressed air. The rearward porous protective surface may assist in reinforcing the forward porous protective surface from contact with components of the processing vessel.

The forward porous protective surface and the rearward porous protective surface may be made of the same material. The forward porous protective surface and the rearward porous protective surface may be made of different materials. The forward porous protective surface and the rearward porous protective surface may be made of any material that protects the separator. The forward porous protective surface and the rearward porous protective surface may be made of any material that may prevent at least some of the solids in the processing vessel from exiting the processing vessel. Preferably, the forward porous protective surface and the rearward porous protective surface may be made of any material that prevents the agitated media from damaging the separator, leaving the processing vessel, or both. The forward porous protective surface and the rearward porous protective surface may be made of any material that does not break down to form a particulate matter, for example, flake, chip, dust, break, or a combination thereof from repeated contact with the contents of the processing vessel. The forward porous protective surface, the rearward porous protective surface, or both may be made of a material that is abrasive resistant, corrosion resistant, or both. The forward porous protective surface and the rearward porous protective surface may be made of a polymeric material, a composite material, a metal, a ceramic, a plastic, a natural material, synthetic material, or a combination thereof. Preferably, the forward porous protective surface and the rearward porous protective surface are made of stainless steel. The forward porous protective surface, the rearward porous protective surface, the separator, or a combination thereof may be held in the separation unit by a friction fit or another component of the separation unit. The forward porous protective surface, the rearward porous protective surface, the separator, or a combination thereof may include an attachment feature for attaching one or all of the components to the interface component. The separation unit may include a spacer for holding the forward porous protective surface, the rearward porous protective surface, the separator, or a combination thereof in place.

The spacer may assist in holding the forward porous protective outface, the rearward porous protective surface, the separator, or a combination thereof in the interface component. The spacer may lock the forward porous protective surface, the rearward porous protective surface, the separator, or a combination thereof between an interface component and a connection adapter. The spacer may be adjustable so that a the size of the forward porous protective surface, the rearward porous protective surface, the separator, or a combination thereof may be varied depending on the contents of the processing vessel. The spacer may be compressible so that when the connection adapter is attached to the interface component the forward porous protective surface, the rearward porous protective surface, the separator, or a combination thereof are not damaged.

The connection adapter may be any device that holds the forward porous protective surface, the rearward porous protective surface, the separator, a spacer, or a combination thereof in the interface component. The connection adapter may be any device that attach the separation unit to the cleaning mechanism. The connection adapter may be attached to the interface component using a fastener. The connection adapter may include a male or female portion so that the connection adapter may be attached to the corresponding male or female portion of the interface component. Preferably, connection adapter and the interface component are bolted together. The connection adapter may form a seal with the isolation pipe so that the fluid inside the isolation pipe remains separated from the outside environment. The connection adapter may be any device that attaches the separation unit to the cleaning mechanism.

A cleaning mechanism may be located proximate to the separation unit. The cleaning mechanism may be any device that removes solids from the separator. The cleaning mechanism may be any device that substantially cleans the separator. The cleaning mechanism may produce a force and the force may impact the separator and remove solids from the separator. The cleaning mechanism may move a fluid into contact with the separator so that the fluid removes, loosens, or both solids on the separator. The cleaning mechanism may assist in venting the processing vessel. For example, the cleaning mechanism may introduce a fluid into the processing vessel creating a positive pressure in the processing chamber so that a fluid is forced back out of the processing vessel through the separation unit and out the vent. The cleaning mechanism may be in fluid communication with the separation unit. Preferably, the cleaning mechanism may be external of the processing vessel. The cleaning mechanism may include one or more of the following features: an isolation pipe, a valve, a compressed gas source, a conduit with at least one exhaust port, or a combination thereof.

The cleaning mechanism may include an isolation pipe. The cleaning mechanism may be free of an isolation pipe. The cleaning mechanism may be attached to the separation unit by an isolation pipe. The isolation pipe may attach to the connection adapter. The isolation pipe may be solid. The isolation pipe may be flexible. The isolation pipe may include a flexible portion. The isolation pipe may dampen vibration from the cleaning mechanism so that the separation unit does not experience vibration from the cleaning mechanism. The isolation pipe may dampen vibration from the processing vessel so that the cleaning mechanism does not experience vibration created by the processing vessel. The isolation pipe may include an exhaust port. The isolation pipe preferably may attach at one end to the separation unit and at an opposing end to the cleaning mechanism.

The cleaning mechanism may include a conduit. The conduit may be any device that assists the processing unit in venting. The conduit may be any device that attaches the cleaning unit indirectly to the separation unit and allows for unwanted gases to be vented from the processing unit. The cleaning mechanism may be free of a conduit. The conduit may attach to a separation unit. Preferably, the conduit attaches to an isolation pipe. The conduit may include a first end, a second end, one or more exhaust ports, or a combination thereof, The conduit may prevent fluid from diffusing back into the processing vessel, during processing, after the separator is cleaned, or a time therebetween. The conduit may include a check valve, a back flow preventer, the like, or a combination thereof. Preferably, the conduit includes at least one exhaust port. The exhaust port may exhaust the fluid extracted from the processing vessel. The exhaust port may exhaust compressed gas. The exhaust port may allow for sired by-products to be removed from the processing unit while maintaining a substantially constant stoichiometry. The exhaust port may allow for moisture to be removed from the processing vessel. The undesired by-products may be water, solvent, volatiles, or any other unwanted gaseous and/or volatile by-product. The exhaust port may allow for the processing vessel to be maintained close to atmospheric pressure, substantially at atmospheric pressure, or both. The first end of the conduit may attach to the separation unit. Preferably, the first end of the conduit attaches to the isolation pipe. The second end of the conduit may attach to a valve, a compressed gas source, or both.

The valve may be any valve that prevents movement of a fluid, a gas, or a solid into the conduit, the isolation pipe, or both. The valve may be a solenoid valve. The valve may be a manual valve. Preferably, the valve is an automatic valve. The valve may be any valve that may prevent fluid flow into the conduit, from the conduit, or both. The valve may be capable of rapidly cycling from open to closed and vice versa. The valve may be able to open and close (i.e., may clean the separator) about 5 times a minute or more, about 10 times a minute or more, about 15 times a minute or more, or about 30 times a minute or more. The valve may be operated in a periodic manner. The valve may be operated in a continuous manner. For example, the valve may remain open while the processing vessel is running so that compressed air is forced towards the processing vessel. The valve when opened may allow compressed gas to exit the compressed gas source so that the fluid flow from the processing vessel is eliminated and the compressed gas and fluid are moved back into the processing vessel. The valve while closed may prevent compressed gas from entering into the processing. The valve when closed may allow fluids from the processing vessel to exit the processing vessel through the separation unit and the exhaust port. Preferably, the valve is connected to a compressed gas source.

The compressed gas source may be any gas source that may clear solids from the separation unit. Preferably, the compressed gas source may be any gas source that may clear solids from the separator without damaging the separation unit, reacting with the fluid, reacting with the solids, or a combination thereof. The compressed gas may be any inert gas, air, nitrogen, or a combination thereof. The pressure of the compressed gas source may be a sufficient pressure so that any solids accumulated on the separator may be loosened from the separator, removed from the separator, or both so that undesired by-products may be removed from the processing vessel. The compressed gas may be capable of providing gas at a pressure sufficient to clean the separator, for example, a low pressure gas source. Preferably, the gas may be a high pressure gas source. The pressure of the compressed as source may be a sufficient pressure to prevent accumulation of solids on the separator while allowing undesired by-products to be removed from the processing vessel. The pressure of the compressed gas source may be a sufficient pressure to stop, reverse, or both the fluid flow from the processing vessel. The pressure of the compressed gas source may be sufficient so that the separator, the forward porous protective surface, or both are flexed during application of the compressed air. The compressed gas may be introduced at a pressure of about 50 KPa or more, about 100 KPa or more, about 150 KPa or more, about 200 KPa or more, preferably about 250 KPa or more, more preferably about 300 KPa or more, even more preferably out 350 KPa or more, or most preferably about 400 KPa or more. The compressed gas may be introduced at a pressure of about 6500 KPa or less, about 5000 KPa or less, about 3500 KPa or less, or about 1725 KPa or less. The pressure of the compressed gas may be inversely proportional to the duration of the compressed gas application. For example, if the compressed gas is applied at a pressure of 250 KPa the duration may be about 100 milliseconds, and if the compressed gas is applied at a pressure of about 500 KPa the duration may be about 40 milliseconds. The duration of a compressed gas apply may be about 2 seconds or less, about 1 second or less, preferably about 700 milliseconds or less, more preferably about 400 milliseconds or less, or most preferably about 300 milliseconds or less so some compressed gas is moved into contact with the separator so that the separator is cleaned. The duration of a compressed gas apply may be about 50 milliseconds or more, about 100 milliseconds or more, or preferably about 200 milliseconds or more, Preferably, a compressed gas apply has a duration of between about 1 second and about 100 milliseconds and preferably between about 500 milliseconds and about 200 milliseconds. The valve may direct the compressed air from the compressed gas source into the conduit, the isolation pipe, the processing vessel, or a combination thereof.

The cleaning mechanism may vent processing vessel continuously. The cleaning mechanism may vent the processing vessel intermittently. The cleaning mechanism may vent the processing vessel on a frequency of about 1 time per minute, preferably about 5 times per minute, more preferably about 15 times per minute so that loosened and/or removed solids are reintroduced into a processing region of the processing vessel. During the step of venting the separator may be cleaned so that a substantially constant stoichiometric ratio is maintained throughout the entire process. During the step of venting unwanted processing by-products may be removed.

The present teachings may include a method for venting a solid state processing vessel so that solids are removed from a fluidic solid dispersion. The method may include mixing one or more solid state particulated reaction ingredients together under conditions in which reactions may occur, undesired by-products may form or both. Mixing may be performed during the milling process or mixing, may be independent of the milling process. The venting of the solid state processing vessel may occur so that a constant stoichiometric ratio of the plurality of solid state particulated ingredients is maintained and undesired by-products are removed. The stoichiometric ratio may be maintained by retaining the solid state particulated ingredients within the solid state processing vessel (i.e. a reaction vessel). The stoichiometric ratio may be maintained by frequently cleaning the separator. The stoichiometric ratio may be maintained by removing any unwanted by-products such as excess water, water vapor, or other components that cause the solid state particulated ingredients to attach to the separator, or a combination thereof. The stoichiometric ratio rosy be maintained by employing one or more or the techniques addressed herein. The unwanted by-products may passively vent from the processing vessel. For example, the unwanted by-products may vent without any external assistance, may vent due to generation of gaseous reaction product may vent due to an increase in temperature due to friction, an increase in temperature due to reactions between products, due to movement of the processing vessel, or a combination thereof. In another example, the unwanted by-products may be actively vented due to the addition of fluid to the processing vessel, external heat an increase in temperature, or a combination thereof. The processing vessel may be vented due to both active and passive conditions. The fluidic permeable separator may be periodically cleared of the one or more solid state particulated reaction ingredients. The fluidic permeable separator may be continuously cleared of the one or more solid state particulated reaction ingredients. The fluidic permeable separator may be actively purged using the cleaning mechanism so that an inert environment is maintained by removing any unwanted processing by-products. The fluidic permeable separator may be actively purged in response to a change in one or more monitored variables. The environment in the processing vessel may be monitored so that once one of the monitored variables changes the processing vessel may be actively purges so that an inert environment is maintained. The cleaning mechanism may monitor the moisture level, the pressure level, the amount of volatiles, or a combination thereof in the processing vessel. The cleaning mechanism may apply a force to the separator so that any solids accumulated on the separator are loosened, removed, or both. The force may be a shock by moving the cleaning mechanism so that a vibration is sent to the separation unit. Preferably, the force is compressed air that is passed backwards into the processing vessel so that any accumulated solids are agitated and removed and/or loosened from the separator. The cleaning mechanism may substantially prevent the formation of any substantial pellicle agglomerates on the separator. The cleaning mechanism may do so by periodically, actively, continuously, or a combination thereof applying a force to the separation unit.

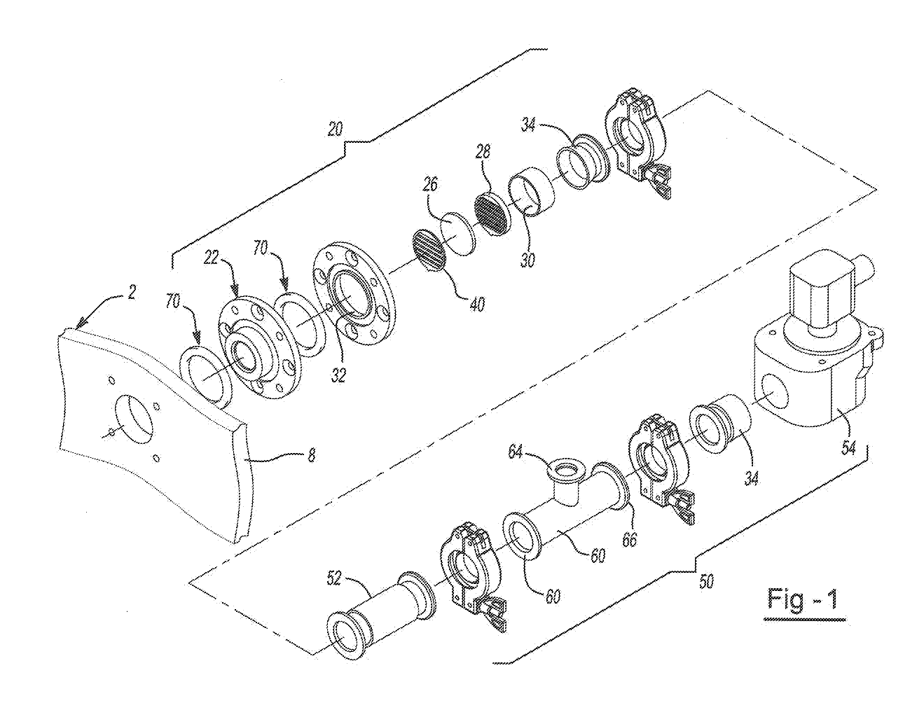

FIG. 1 illustrates an exploded view of a separation unit 20 and cleaning mechanism 50 for venting a processing vessel 2. An interface component 22 connects the separation unit 20 to a wall 8 of the processing vessel. A seal 70 is located between the interface component 22 and the wall 8. The interface component 22 houses a forward porous protective surface 40, a separator 26, and a rearward porous protective surface 28. A spacer is located between the rearward porous protective surface 28 and a connection adapter 32 so that when the interface component 22 and the connection adapter 32 are connected the forward porous protective surface 40, separator 26, and rearward porous protective surface 28 are retained in place. A seal 70 is located between the interface component 22 and the connection adapter 32 so that all of the fluid solid dispersant travels through the separation unit 20. The separation unit 20 is connected to the cleaning mechanism 50 we a connector 34. The coupling adapter 34 connects to an isolation pipe 52. The isolation pipe 52 connects to a conduit 60 having a first end 52 and a second end 66 with a vent 64 therebetween. The conduit 60 is connected to a connector 34 that attaches directly to a valve 54 of the cleaning mechanism 50.

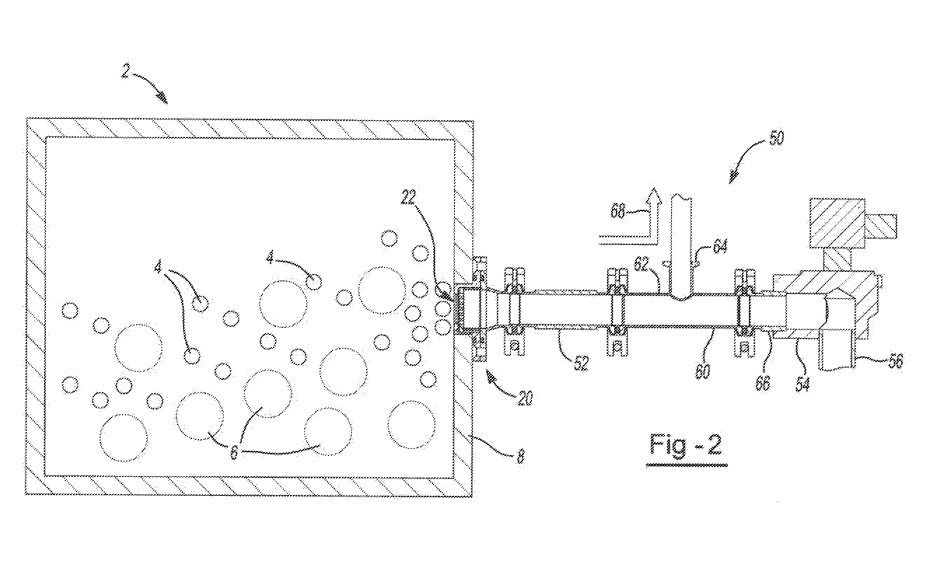

FIG. 2 illustrates a processing vessel 2 during venting. The processing vessel 2 including a plurality of solid state particulated reaction ingredients 4 and milling media 6. The milling media 6 mill and or refine the solid state particulated reaction ingredients 4 causing unwanted by-products which should be vented hen the processing vessel 2 without removal of any of the solid state particulated reaction ingredients 4. One wall 8 of the processing vessel 2 includes a separation unit 20. A cleaning mechanism 50 is connected to the separation unit 20 on a side opposing the processing vessel 2. As illustrated, the front of the separation unit 20 is coplanar with one wail 8 of the processing vessel 2. The cleaning mechanism 50 includes an isolation pipe 52, conduit 60, a valve 54, and a compressed gas source 56. The cleaning mechanism 50 is attached to the separation unit 20 via the isolation pipe 52 that is attached to a first end 62 of the conduit 60. The conduit 60 includes a vent 64 between the first end 62 and the second end 66. The valve 65 is in the dosed position and the valve 65 is blocking the compressed gas source 56 so that unwanted processing by-products are vented through the vent 64 in the direction of the arrow 68. As illustrated, the solid state particulated reaction ingredients 4 are separated from the fluidic solid dispersion by the separation unit 20 so that the solid state particulated reaction ingredients 4 are retained within the processing vessel 2 and the unwanted processing by-products are vented in the direction of the arrow 68.

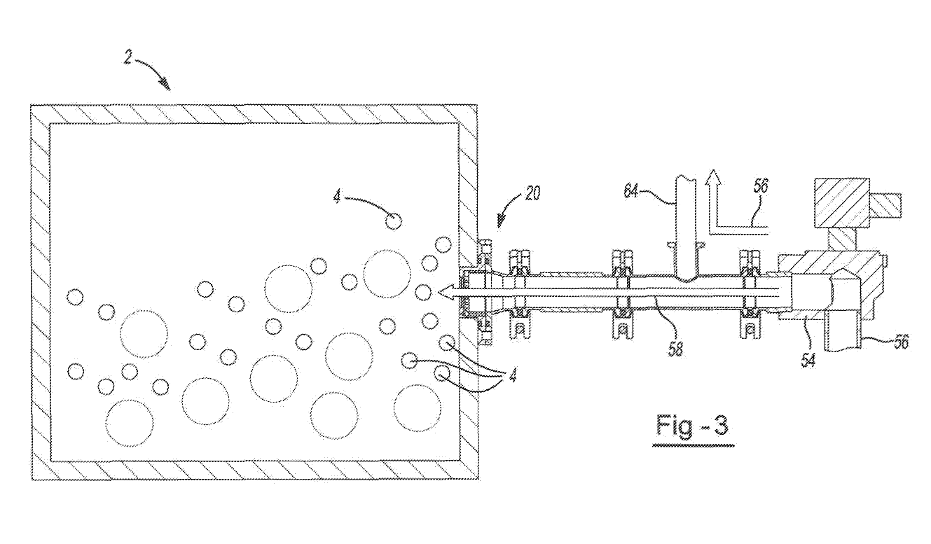

FIG. 3 illustrates a processing vessel 2 during cleaning or purging of the s unit 20. The valve 54 is open and the compressed gas source 56 releases compressed gas 58 towards and into the processing vessel 2 through the separation unit 20. The compressed gas 58 clears the solid state particulated reaction ingredients 4 from the separator (not shown) of the separation unit 20 back into the processing vessel 2 so that the stoichiometric ratio of the solid state particulated reaction ingredients are not affected. The compressed gas 56 further passes through the vent 64 pushing any unwanted processing by-products out of the system.

FIG. 4 illustrates a cross-sectional view of a wall 8 of a processing vessel 2 with the separation unit 20 forming a portion of the wall 8, and the separation unit being attached to a cleaning mechanism 50. The cleaning mechanism 50 is attached to the separation unit via an isolation pipe 52. The isolation pipe 52 is flexible so that vibrations from the processing vessel 2 and cleaning mechanism are not translated to other respective device. The isolation pipe 52 is attached to a conduit 60 at a first end 62. The conduit 60 as illustrated includes one vent 64. The conduit 60 is attached to a valve 54 at a second end 66. The valve 54 allows compressed gas 58 to be released from the compressed gas source (not shown) into the cleaning mechanism 50, the separation unit 20, and into the processing vessel 2.

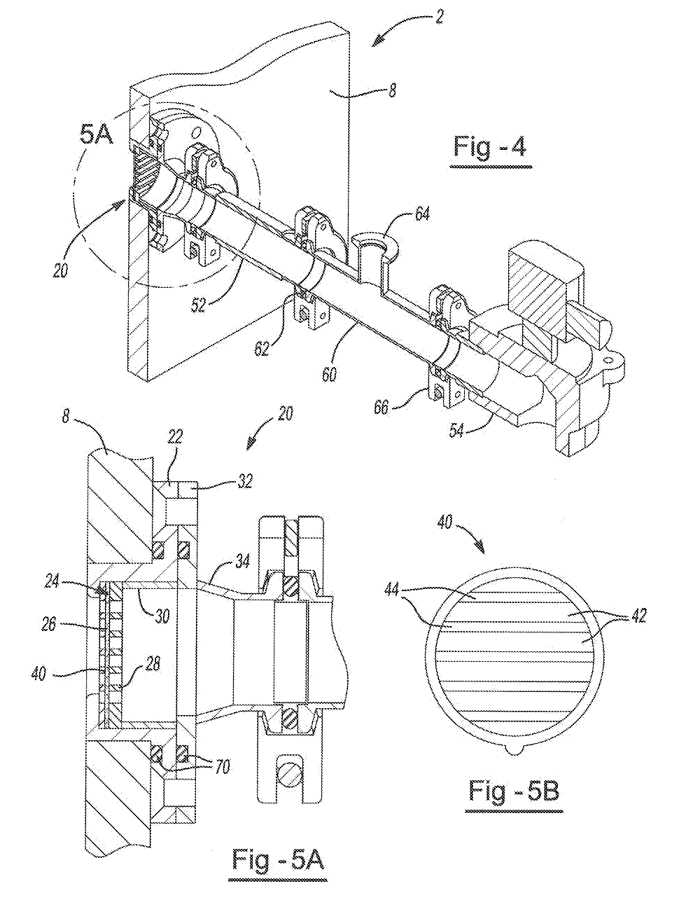

FIG. 5A illustrates a cross-sectional view of the separation unit 20. The separation unit 20 includes an interface component 22 that is attached to the wall 8 of the processing vessel 2 using a fastener (not shown). The front of the interface component 22 is coplanar with the front of the wall 8 as illustrated. The interface component 22 includes a forward protective surface 24, and the forward protective surface 24 as illustrated is chamfered. A forward porous protective surface 40, a separator 26, a rearward porous protective surface 28, and a spacer 30 are sandwiched between the interface component 22 and a connection adapter 32. As illustrated the interface component 22 and the connection adapter 32 are attached to the wall 8 via a fastener (now shown). The separation unit 20 includes a seal 70 between the wall 8 and the interface component 22 and between the interface component 22 and the connection adapter 32. FIG. 5B illustrates a front view of the forward porous protective surface 40. The forward porous protective surface 40 includes protection members 44 with pores 42 between the protection members 44.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc, are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components o steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe en element, ingredient, component or step is not intended to foreclose additional elements, ingredients, components or steps.

1) An article comprising:
a. a separation unit including a fluid permeable separator having a membrane for separating a solid from a fluid present in a fluidic solid dispersion, the separation unit having an interface component for attachment to a wall of a processing vessel in a manner so that the interface component generally integrates with the wall forming a substantially contiguous wall surface and
b. a cleaning mechanism that is in fluid communication with the separation unit and that is adapted to extract the fluid that is separated from the fluidic solid dispersion from the processing vessel, and to periodically and/or continuously agitating the solids on the surface of the separation unit so that the fluid can pass through the separator.

2) The article of claim 1, wherein the processing vessel is adapted for processing at least one solid material.

3) The article of claim 1, wherein the solids accumulated on a surface of the separation unit are dislodged, loosened, or both by the periodic and/or continuous agitation of the separation unit.

4) The article of claim 1, wherein the separation unit is generally planar and generally contiguous with the wall.

5) The article of claim 1, wherein the separation unit includes a forward porous protective surface.

6) The article according to claim 1, wherein the forward porous protective surface is flexible so that the forward porous protective surface flexes during cleaning.

7) The article according to claim 1, wherein the cleaning mechanism is external of the vessel and the cleaning mechanism is located adjacent to the separation unit and at a location further from the processing vessel than the separation unit.

8) The article according to claim 1, wherein the cleaning mechanism includes: a compressed gas source having an outlet connected with a valve through which the compressed fluid is emitted.

9) The article according to claim 1, wherein the cleaning mechanism includes a conduit with a first end, a second end, and at least one exhaust port, and the first end couples with the separation unit and the second end is coupled with a compressed air source.

10) (canceled)

11) The article according to claim 1, wherein the fluid permeable separator is part of an interface component and is sandwiched between a forward porous protective surface and an optional rear support.

12) (canceled)

13) (canceled)

14) A process of producing a battery electrode material using a vessel including the article according to claim 1, wherein the processing vessel is vented on a frequency of more than one time per minute so that loosened and/or removed solids are reintroduced into a processing region of the processing vessel.

15) The process of claim 14, including a step of maintaining a substantially constant stoichiometric ratio throughout the processing and also removing unwanted processing by-products.

16) A method comprising:
a. mixing a plurality of solid state particulated reaction ingredients under conditions in which reactions occur, undesired by-products form, or both and
b. venting a solid state processing vessel through a separation unit having a membrane, the separation unit being contiguous with a wall of the processing vessel so that a constant stoichiometric ratio of the plurality of solid state particulated reaction ingredients is maintained, and undesired by-products are removed.

17) The method of claim 16, wherein venting includes separating the fluid through a fluid permeable separator positioned in a separation unit.

18) The method according to claim 16, wherein the fluid permeable separator is periodically cleared of the plurality of solid state particulated reaction ingredients.

19) The method according to claim 16, wherein the fluid permeable separator is actively cleared using a cleaning mechanism so that an inert environment is maintained by removing any unwanted processing byproducts, and
wherein the step of clearing the separator includes applying a force to the separation unit to agitate solids accumulated thereon.

20) (canceled)

21) The method according to claim 16, wherein venting the solid state processing vessel includes a step of preventing the formation of any substantial particle agglomerates by periodically applying a force to the separation unit.

22) The method according to claim 16, wherein the plurality of solid state particulated reaction ingredients are battery electrode precursors.

23) (canceled)

24) The method according to claim 16, wherein a substantial portion of the undesired by-products removed are water.

25) (canceled)

26) The method according to claim 16, wherein mixing step includes agitating a milling media.

27) (canceled)

28) (canceled)
